(19) United States
(12) Patent Application Publication
(10) Pub. No.: US 2010/0045949 A1
(43) Pub. Date: Feb. 25, 2010

(54) Exposure apparatus, maintaining method and device fabricating method

(75) Inventors: Katsushi Nakano, Kumagaya-shi (JP); Tomoharu Fujiwara, Gyoda-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/461,370

(22) Filed: Aug. 10, 2009

Related U.S. Application Data
(60) Provisional application No. 61/136,272, filed on Aug. 22, 2008.
(60) Provisional application No. 61/193,847, filed on Dec. 30, 2008.

(30) Foreign Application Priority Data
Aug. 11, 2008 (JP) 2008-206750
Dec. 12, 2008 (JP) 2008-317563

(51) Int. Cl. G03B 27/52

(52) U.S. Cl. 355/30

(57) ABSTRACT

An exposure apparatus exposes a substrate with exposure light that passes through a liquid. The exposure apparatus comprises: a porous member that has a first surface, which is capable of opposing an object disposed at an irradiation position of the exposure light, and a second surface, which is opposite the first surface, and forms a first space that is capable of holding the liquid between the first surface and the object; a supply port, which is capable of supplying the liquid to the first space; a prescribed member, which forms a second space that faces the second surface; an adjusting apparatus, which is capable of decreasing a pressure in the second space such that the liquid in the first space moves to the second space via holes in the porous member; and a control apparatus, which controls an operation of supplying the liquid via the supply ports and a pressure adjustment operation performed by the adjusting apparatus. The control apparatus repetitively executes a first operation, which supplies the liquid to the first space, and a second operation, which stops the supply of the liquid to the first space and negatively pressurizes the second space such that the liquid is substantially eliminated from the first space, to clean the porous member.

### CROSS-REFERENCE TO RELATED APPLICATION

This application is a non-provisional application claiming priority to and the benefit of U.S. provisional application Nos. 61/136,272, filed Aug. 22, 2008, and 61/193,847, filed Dec. 30, 2008, and claims priority to Japanese Patent Application Nos. 2008-206750, filed Aug. 11, 2008, and 2008-317563, filed Dec. 12, 2008. The entire contents of which are incorporated herein by reference.

### BACKGROUND

1. Field of the Invention

The present invention relates to an exposure apparatus that exposes a substrate with exposure light that passes through a liquid, a method of maintaining the exposure apparatus, and a method of fabricating a device.

2. Related Art

Among exposure apparatuses used in photolithography, one that is well known is an immersion exposure apparatus that exposes a substrate with exposure light that passes through a liquid. U.S. Patent Application Publication No. 2006/0152697 discloses one example of a technology related to an immersion exposure apparatus that recovers a liquid via a porous member.

In an immersion exposure apparatus, a member used in the recovery of the liquid might become contaminated. If, for example, foreign matter is adhered to the member and the porous member is left in that state, such foreign matter might cause defects in the pattern formed on the substrate and, in turn, cause exposure failures. As a result, defective devices might be produced.

An object of the present invention is to provide an immersion exposure apparatus that can prevent exposure failures from occurring. Another object of the present invention is to provide a maintaining method that can prevent exposure failures from occurring. Another object of the present invention is to provide a device fabricating method that can prevent defective devices from being produced.

### SUMMARY

A first aspect of the invention provides an exposure apparatus that exposes a substrate with exposure light that passes through a liquid and comprises: a porous member that has a first surface, which is capable of opposing an object disposed at an irradiation position of the exposure light, and a second surface, which is on the opposite side of the first surface, and forms a first space that is capable of holding the liquid between the first surface and the object; a supply port, which is capable of supplying the liquid to the first space; a prescribed member, which forms a second space that faces the second surface; an adjusting apparatus, which is capable of decreasing a pressure in the second space such that the liquid in the first space moves to the second space via holes in the porous member; and a control apparatus, which controls an operation of supplying the liquid via the supply ports and a pressure adjustment operation performed by the adjusting apparatus; wherein, the control apparatus repetitively executing a first operation, which supplies the liquid to the first space, and a second operation, which stops the supply of the liquid to the first space and decreases a pressure in the second space such that the liquid is substantially eliminated from the first space, to clean the porous member.

A second aspect of the invention provides an exposure apparatus that exposes a substrate with exposure light that passes through a liquid and comprises: a porous member that has a first surface, which is capable of opposing an object disposed at an irradiation position of the exposure light, and a second surface, which is on the opposite side of the first surface, and forms a first space that is capable of holding the liquid between the first surface and the object; a supply port, which is capable of supplying the liquid to the first space; a prescribed member, which forms a second space that faces the second surface; an adjusting apparatus, which is capable of decreasing a pressure in the second space; and a control apparatus, which controls an operation of supplying the liquid via the supply ports and a pressure adjustment operation performed by the adjusting apparatus; wherein, when the substrate is not being exposed, the control apparatus cleans the porous member by, while supplying the liquid to the first space, decreasing a pressure in the second space such that the pressure differential between pressures at the first surface and at the second surface is greater than the pressure differential between pressures at the first surface and at the second surface during an exposure of the substrate.

A third aspect of the invention provides a device fabricating method that comprises the steps of: exposing a substrate using an exposure apparatus according to any one aspect of the first through second aspects; and developing the exposed substrate.

A fourth aspect of the invention provides a method of maintaining an exposure apparatus that exposes a substrate with exposure light that passes through a liquid and comprises the steps of: causing an object and a porous member, which is capable of recovering the liquid from a front surface of the substrate during an exposure of the substrate, to oppose one another; and cleaning the porous member by repetitively transitioning between a first state, wherein the liquid is supplied to a first space between the porous member and the object and at least part of the first space is filled with the liquid, and a second state, wherein the supply of the liquid to the first space is stopped and the liquid is substantially eliminated from the first space.

A fifth aspect of the invention provides a method of maintaining an exposure apparatus that exposes a substrate with exposure light that passes through a liquid and comprises the steps of: causing an object and a porous member, which is capable of recovering the liquid from a front surface of the substrate during an exposure of the substrate, to oppose one another; and cleaning the porous member by, while supplying the liquid to a first space between the porous member and the object, adjusting the negative pressure in the second space such that the liquid and a gas move to a second surface of the porous member, which is on the opposite side of a first surface thereof that faces the first space, via holes of the porous member.

A sixth aspect of the invention provides a method of maintaining an exposure apparatus that that exposes a substrate with exposure light that passes through a liquid, and comprises the steps of: causing an object and a recovery port, which is capable of recovering the liquid from a front surface of the substrate during an exposure of the substrate, to oppose one another; and while supplying a liquid onto the object, repetitively transitioning between a pressurization of a recovery passageway, which is connected with the recovery port, and a depressurization of the recovery passageway.

A seventh aspect of the invention provides a device fabricating method that comprises the steps of: exposing a substrate using an exposure apparatus that is maintained by the maintaining method according to any one aspect of the fourth, fifth and sixth aspects; and developing the exposed substrate.

According to some aspects of the present invention, it is possible to prevent exposure failures from occurring and thereby to prevent defective devices from being produced.

### BRIEF DESCRIPTION OF THE DRAWINGS

FIG. 1 is a schematic block drawing that shows one example of an exposure apparatus according to the first embodiment.

FIG. 2 is a side cross sectional view that shows one example of a liquid immersion member and a substrate stage according to the first embodiment.

FIG. 3 is a partial, enlarged, side cross sectional view of the liquid immersion member according to the first embodiment.

FIG. 4A includes a schematic drawing for explaining one example of the exposing method according to the first embodiment.

FIG. 4B includes a schematic drawing for explaining one example of the exposing method according to the first embodiment.

FIG. 5A includes a schematic drawing for explaining one example of a maintaining method according to the first embodiment.

FIG. 5B includes a schematic drawing for explaining one example of a maintaining method according to the first embodiment.

FIG. 5C includes a schematic drawing for explaining one example of a maintaining method according to the first embodiment.

FIG. 6A includes a schematic drawing for explaining one example of the maintaining method according to the first embodiment.

FIG. 6B includes a schematic drawing for explaining one example of the maintaining method according to the first embodiment.

FIG. 7A includes a schematic drawing for explaining one example of the maintaining method according to the first embodiment.

FIG. 7B includes a schematic drawing for explaining one example of the maintaining method according to the first embodiment.

FIG. 8 is a schematic drawing that shows one example of the behavior of the liquid according to the second embodiment.

FIG. 9A includes a schematic drawing for explaining one example of a maintaining method according to the second embodiment.

FIG. 9B includes a schematic drawing for explaining one example of a maintaining method according to the second embodiment.

FIG. 10 is a flow chart for explaining one example of a process of fabricating a microdevice.

### DESCRIPTION OF EMBODIMENTS

The following text explains the embodiments of the present invention referencing the drawings, but the present invention is not limited thereto. The explanation below defines an XYZ orthogonal coordinate system, and the positional relationships among members are explained referencing this system. Prescribed directions within the horizontal plane are the X axial directions, directions orthogonal to the X axial directions in the horizontal plane are the Y axial directions, and directions orthogonal to the X axial directions and the Y axial directions are the Z axial directions (i.e., the vertical directions). In addition, the rotational (i.e., inclinational) directions around the X, Y, and Z axes are the θX, θY, and θZ directions, respectively.

### First Embodiment

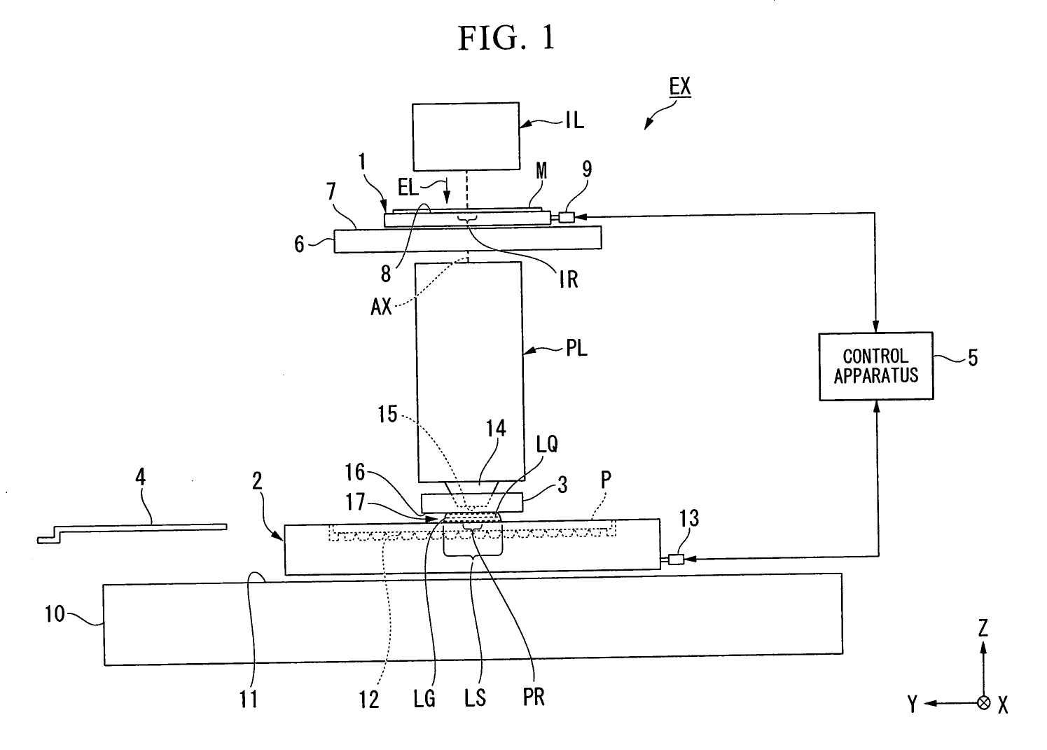

FIG. 1 is a schematic block drawing that shows one example of an exposure apparatus EX according to the first embodiment. The exposure apparatus EX of the present embodiment is an immersion exposure apparatus that exposes a substrate P with exposure light EL that passes through a liquid LQ. In the present embodiment, water (i.e., pure water) is used as the liquid LQ.

In FIG. 1, the exposure apparatus EX comprises: a movable mask stage 1 that holds a mask M; a movable substrate stage 2 that holds the substrate P; an illumination system IL that illuminates the mask M with the exposure light EL; a projection optical system PL that projects an image of a pattern of the mask M, which is illuminated by the exposure light EL, to the substrate P; a liquid immersion member 3, which is capable of forming an immersion space LS such that at least part of the optical path of the exposure light EL is filled with the liquid LQ; a transport apparatus 4, which is capable of transporting the substrate P; and a control apparatus 5 that controls the operation of the entire exposure apparatus EX.

The illumination system IL radiates the exposure light EL to a prescribed illumination region IR. The illumination region IR includes an irradiation position of the exposure light EL that emerges from the illumination system IL. The illumination system IL illuminates at least part of the mask M disposed in the illumination region IR with the exposure light EL, which has a uniform luminous flux intensity distribution. Examples of light that can be used as the exposure light EL that emerges from the illumination system IL include: bright line (g-line, h-line, or i-line) light emitted from, for example, a mercury lamp; deep ultraviolet (DUV) light, such as KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 7 of a base member 6, which includes the illumination region IR. The mask stage 1 comprises a mask holding part 8 that releasably holds the mask M. The mask stage 1 is capable of moving—by the operation of a drive system 9 that comprises, for example, linear motors—on the guide surface 7 in three directions: the X axial, Y axial, and θZ directions.

The projection optical system PL radiates the exposure light EL to a prescribed projection region PR. The projection region PR includes an irradiation position of the exposure light EL that emerges from the projection optical system PL. The projection optical system PL projects with a prescribed projection magnification an image of the pattern of the mask M to at least part of the substrate P, which is disposed in the projection region PR. The projection optical system PL of the present embodiment is a reduction system that has a projection magnification of, for example, ¼, ⅕, or ⅛. Furthermore, the projection optical system PL may also be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

In the state wherein it holds the substrate P, the substrate stage 2 is capable of moving on a guide surface 11 of a base member 10, which includes the projection region PR. The substrate stage 2 comprises a substrate holding part 12, which releasably holds the substrate P. The substrate holding part 12 comprises a so-called pin chuck mechanism, as disclosed in, for example, U.S. Patent Application Publication No. 2007/0177125, and can releasably hold the substrate P. The substrate stage 2 is capable of moving—by the operation of a drive system 13 that comprises, for example, linear motors—on the guide surface 11 in six directions: the X axial, Y axial, Z axial, θX, θY, and θZ directions.

In the present embodiment, an interferometer system (not shown), which comprises laser interferometers, measures the positions of the mask stage 1 and the substrate stage 2. When an exposing process or a prescribed measuring process is performed on the substrate P, the control apparatus 5 controls the positions of the mask stage 1 (i.e., the mask M) and the substrate stage 2 (i.e., the substrate P) by driving the drive systems 9, 13 based on the measurement results of the interferometer system.

The liquid immersion member 3 is capable of forming the immersion space LS such that at least part of the optical path of the exposure light EL is filled with the liquid LQ. The immersion space LS is a portion (i.e., a space or area) that is filled with the liquid LQ. The liquid immersion member 3 is disposed in the vicinity of a last optical element 14, which is the optical element of the plurality of optical elements of the projection optical system PL that is closest to the image plane of the projection optical system PL. In the present embodiment, the liquid immersion member 3 is a ring shaped member and is disposed around the optical path of the exposure light EL. In the present embodiment, at least part of the liquid immersion member 3 is disposed around the last optical element 14.

The last optical element 14 has an emergent surface 15 wherefrom the exposure light EL emerges and travels toward the image plane of the projection optical system PL. In the present embodiment, the immersion space LS is formed such that the optical path of the exposure light EL between the last optical element 14 and an object, which is disposed at the irradiation position (i.e., the projection region PR) of the exposure light EL that emerges from the last optical element 14, is filled with the liquid LQ. In the present embodiment, the object that is capable of being disposed in the projection region PR includes either the substrate stage 2 or the substrate P, which is held by the substrate stage 2, or both.

In the present embodiment, the liquid immersion member 3 has a lower surface 16 that is capable of opposing the object disposed in the projection region PR. The liquid immersion member 3 forms a first space 17, which is capable of holding the liquid LQ between the lower surface 16 and the object disposed on the projection region PR side. Holding the liquid LQ between the emergent surface 15 and the lower surface 16 on one side and the front surface of the object on the other side forms the immersion space LS such that the optical path of the exposure light EL between the last optical element 14 and the object is filled with the liquid LQ.

In the present embodiment, when the substrate P is being irradiated with the exposure light EL, the immersion space LS is already formed such that part of the area of the front surface of the substrate P that includes the projection region PR is covered with the liquid LQ. At least part of an interface LG (i.e., a meniscus or edge) of the liquid LQ is formed between the lower surface 16 of the liquid immersion member 3 and the front surface of the substrate P. Namely, the exposure apparatus EX of the present embodiment adopts a local liquid immersion system.

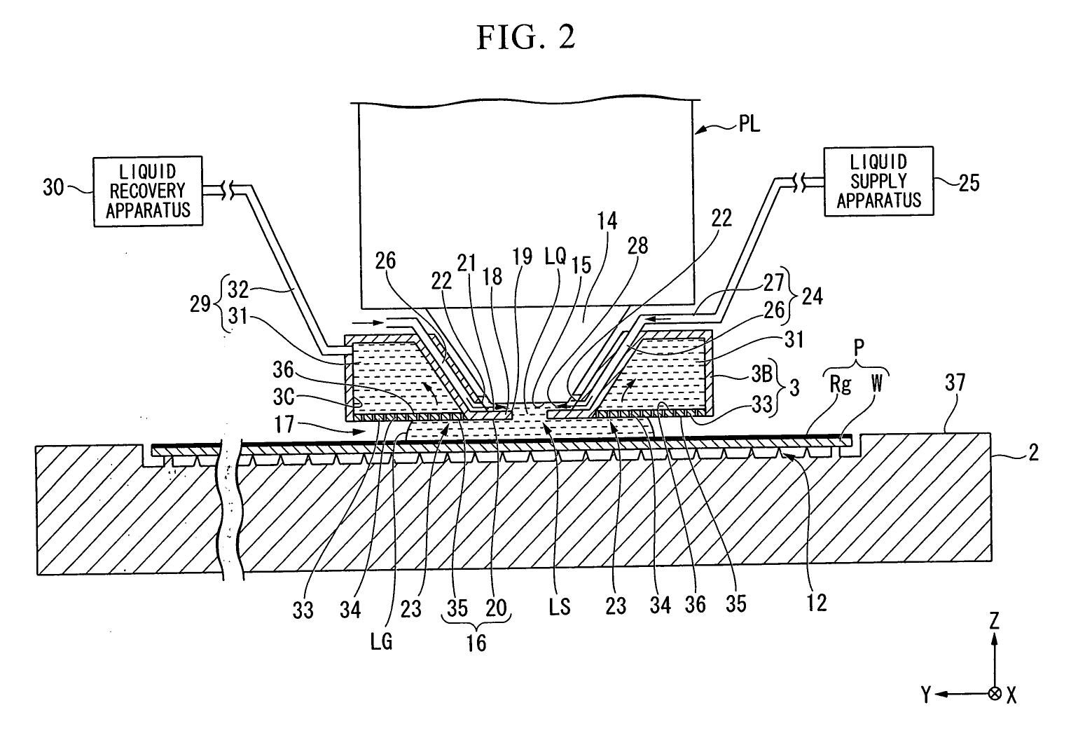

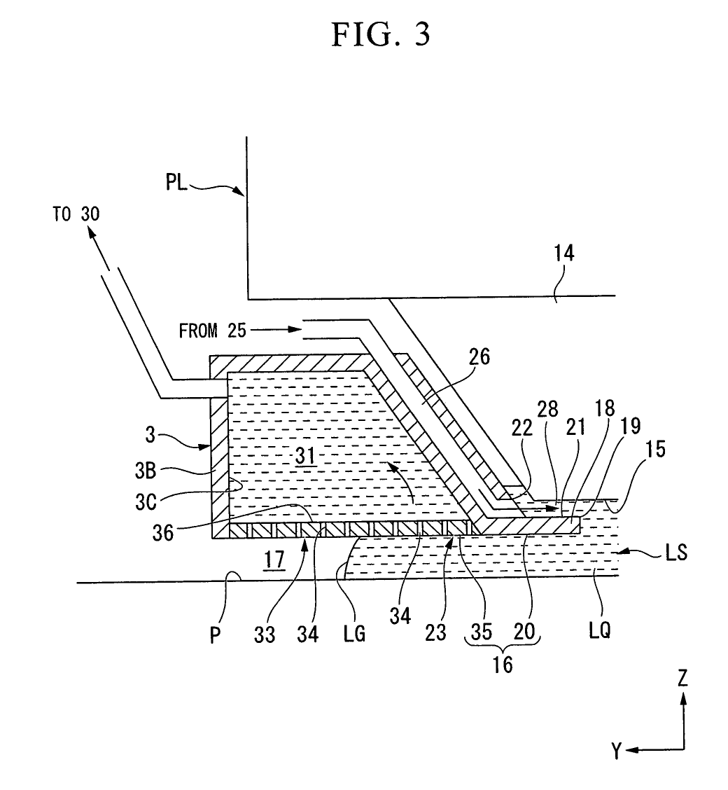

FIG. 2 is a side cross sectional view that shows one example of the liquid immersion member 3 and the substrate stage 2 according to the present embodiment, and FIG. 3 shows an enlarged side cross sectional view of part of FIG. 2. To simplify the explanation, the following text principally explains an exemplary state wherein the substrate P opposes the last optical element 14 and the liquid immersion member 3. Furthermore, as discussed above, an object other than the substrate P, for example, the substrate stage 2, can also be disposed at a position at which it opposes the last optical element 14 and the liquid immersion member 3.

As shown in FIG. 2 and FIG. 3, in the present embodiment, the liquid immersion member 3 comprises a main body member 3B and a porous member 33. In the present embodiment, the main body member 3B is made of titanium. The porous member 33 is plate shaped and has a plurality of holes (i.e., openings or pores). In the present embodiment, the porous member 33 is a mesh plate wherein numerous small holes 34 are formed in a mesh. In the present embodiment, the porous member 33 is made of titanium.

The main body member 3B comprises a plate part 18, at least part of which is disposed between the emergent surface 15 of the last optical element 14 and the front surface of the substrate P in the Z axial directions. The plate part 18 has an opening 19 at its center. In addition, the plate part 18 has: a lower surface 20, which is disposed around the opening 19 and is capable of opposing the substrate P (i.e., the object) disposed at the irradiation position (i.e., the projection region PR) of the exposure light EL; and an upper surface 21, which faces the opposite direction to that faced by the lower surface 20. At least part of the upper surface 21 opposes part of the emergent surface 15. The exposure light EL that emerges from the emergent surface 15 can pass through the opening 19. For example, during an exposure of the substrate P, the exposure light EL that emerges from the emergent surface 15 passes through the opening 19 and is radiated through the liquid LQ to the front surface of the substrate P.

Furthermore, the main body member 3B comprises supply ports 22, which are capable of supplying the liquid LQ to the first space 17, and a recovery port 23, which is capable of recovering the liquid LQ from the first space 17. The supply ports 22 are connected to a liquid supply apparatus 25 via passageways 24. The liquid supply apparatus 25 is capable of supplying the liquid LQ, which is pure and temperature adjusted, to the supply ports 22. Each passageway 24 comprises a supply passageway 26, which is formed inside the main body member 3B, and a passageway 27, which is formed from a supply pipe that connects the supply passageway 26 and the liquid supply apparatus 25. The liquid LQ that is fed from the liquid supply apparatus 25 is supplied to each of the supply ports 22 through the corresponding passageway 24. The supply ports 22 are disposed in the vicinity of the optical path at prescribed positions of the main body member 3B that face the optical path. In the present embodiment, the supply ports 22 supply the liquid LQ to a space 28 between the emergent surface 15 and the upper surface 21. The liquid LQ supplied to the space 28 from the supply ports 22 is supplied to the first space 17 via the opening 19.

The recovery port 23 is capable of recovering the liquid LQ from the first space 17. The recovery port 23 is connected to a liquid recovery apparatus 30 via a passageway 29. The liquid recovery apparatus 30 comprises a vacuum system and is capable of recovering the liquid LQ by suctioning it via the recovery port 23. The passageway 29 comprises a recovery passageway 31, which is formed inside the liquid immersion member 3, and a passageway 32, which is formed from a recovery pipe that connects the recovery passageway 31 and the liquid recovery apparatus 30. The liquid recovery apparatus 30 recovers the liquid LQ recovered via the recovery port 23 through the passageway 29.

In the present embodiment, the recovery port 23 is disposed around the optical path of the exposure light EL. The recovery port 23 is disposed at a prescribed position in the main body member 3B such that it is capable of opposing the front surface of the substrate P. The recovery port 23 is capable of recovering at least part of the liquid LQ on the substrate P that opposes the lower surface 16 of the liquid immersion member 3.

The porous member 33 is disposed in the recovery port 23. In the present embodiment, the porous member 33 comprises a lower surface 35, which is capable of opposing the substrate P disposed at the irradiation position (i.e., the projection area PR) of the exposure light EL, an upper surface 36, which faces a direction opposite that faced by the lower surface 35, and the holes 34, which connect the lower surface 35 and the upper surface 36 on the opposite side of the lower surface 35. Multiple holes 34 are formed.

In the present embodiment, the lower surface 16 of the liquid immersion member 3 includes the lower surface 20 of the main body member 3B (i.e., the plate part 18) and the lower surface 35 of the porous member 33, which is disposed around the lower surface 20 and is capable of opposing the substrate P. The lower surface 16 faces the substrate P (i.e., the object) disposed in the projection area PR. The first space 17, which is capable of holding the liquid LQ between the lower surface 16 and the substrate P (i.e., the object), is formed as discussed above, and the porous member 33 is capable of forming the first space 17, which can hold the liquid LQ between the lower surface 35 and the substrate P.

In the present embodiment, at least part of the recovery passageway 31 is formed between the main body member 3B and the porous member 33. In the present embodiment, the recovery passageway 31 includes the space between an inner surface 3C of the main body member 3B and the upper surface 36 of the porous member 33. The upper surface 36 of the porous member 33 faces the recovery passageway 31. In the explanation below, the recovery passageway 31, which faces the upper surface 36 of the porous member 33, is called the second space 31 where appropriate.

The lower end of each of the holes 34 faces the first space 17, and the upper end of each of the holes 34 faces the second space 31. The first space 17 is connected to the second space 31 via the holes 34. The liquid LQ in the first space 17 is capable of moving to the second space 31 via the holes 34.

The liquid recovery apparatus 30 is capable of adjusting the pressure in the second space 31. The liquid recovery apparatus 30 adjusts the pressure differential between pressures at the lower surface 35 and at the upper surface 36 by adjusting the pressure in the second space 31. In the present embodiment, the pressure surrounding the first space 17 that includes the lower surface 35 is substantially atmospheric pressure, and the liquid recovery apparatus 30 is capable of adjusting the pressure in the second space 31 that includes the upper surface 36 such that it is lower than the pressure in the first space 17.

The liquid recovery apparatus 30 is capable of adjusting the pressure in the second space 31 to a negative pressure such that the liquid LQ of the first space 17 moves to the second space 31 via the holes 34 of the porous member 33. In other words, the liquid recovery apparatus 30 is capable of decreasing the pressure in the second space 31. By adjusting the pressure (by decreasing the pressure) in the second space 31 to a negative pressure, the liquid LQ in the first space 17 moves to the second space 31 via the holes 34 of the porous member 33. By adjusting the pressure in the second space 31 to a negative pressure, the liquid LQ in the first space 17 that contacts, for example, the lower surface 35 of the porous member 33 moves to the second space 31. The liquid recovery apparatus 30 then recovers the liquid LQ that moved to the second space 31 through the passageway 32.

The control apparatus 5 can control the operation of the liquid supply apparatus 25 and the liquid supply operation of the supply ports 22. In addition, the control apparatus 5 can control the pressure adjustment operation of the liquid recovery apparatus 30 with respect to the second space 31.

In the present embodiment, to form the immersion space LS with the liquid LQ between the last optical element 14 and the liquid immersion member 3 on one side and the substrate P on the other side, the control apparatus 5 supplies the liquid LQ from the supply ports 22 to the first space 17 and, while doing so, adjusts the pressure in the second space 31 to a negative pressure so as to recover the liquid LQ via the holes 34 (i.e., the recovery port 23) of the porous member 33. Performing the liquid supply operation using the supply ports 22 and the liquid recovery operation using the porous member 33 forms the immersion space LS between the last optical element 14 and the liquid immersion member 3 on one side and the substrate P on the other side. At least part of the liquid LQ in the immersion space LS is disposed in the first space 17.

As shown in FIG. 2, the substrate stage 2 comprises the substrate holding part 12, which releasably holds the substrate P. The substrate stage 2, which releasably holds the substrate P, is capable of doing so at a position at which the substrate P opposes the lower surface 16 of the liquid immersion member 3 that includes the lower surface 35 of the porous member 33. In the present embodiment, an upper surface 37 of the substrate stage 2, which is disposed around the substrate holding part 12, is substantially parallel to the XY plane. In addition, the substrate holding part 12 of the present embodiment holds the substrate P such that the front surface of the substrate P and the upper surface 37 are disposed substantially within the same plane (i.e., they are flush with one another).

In the present embodiment, the substrate P comprises a base material W (e.g., a semiconductor wafer, such as a silicon wafer) and a photosensitive film Rg that is formed on the base material W. In the present embodiment, the front surface of the substrate P includes the front surface of the photosensitive film Rg. The photosensitive film Rg is made of a photosensitive material (e.g., photoresist). Furthermore, in addition to the photosensitive film Rg, the substrate P may include a separate film. For example, the substrate P may include an antireflection film or a protective film (i.e., a topcoat film) that protects the photosensitive film Rg.

The following text explains one example of a method of using the exposure apparatus EX discussed above to expose the substrate P.

The control apparatus 5 uses the transport apparatus 4 to load the unexposed substrate P onto the substrate stage 2. The substrate stage 2 holds the loaded substrate P with the substrate holding part 12. Once the substrate P is held by the substrate holding part 12, the control apparatus 5 both moves the substrate stage 2 to a position at which the substrate stage 2 opposes the emergent surface 15 and the lower surface 16 and forms the immersion space LS with the liquid LQ between the last optical element 14 and the liquid immersion member 3 on one side and the substrate P (i.e., the substrate stage 2) on the other side.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. When the substrate P is being exposed, the mask M and the substrate P are moved in prescribed scanning directions within the XY plane. In the present embodiment, the scanning directions (i.e., the synchronous movement directions) of both the substrate P and the mask M are the Y axial directions. The control apparatus 5 moves the substrate P in the Y axial directions with respect to the projection region PR and radiates the exposure light EL to the substrate P through the projection optical system PL and the liquid LQ in the immersion space LS while moving the mask M with respect to the illumination region IR in the Y axial directions synchronized to the movement of the substrate P in the Y axial directions. Thereby, the substrate P is exposed by the exposure light EL, which is projected from the projection optical system PL (i.e., the last optical element 14) through the liquid LQ, and the image of the pattern of the mask M is projected to the substrate P.

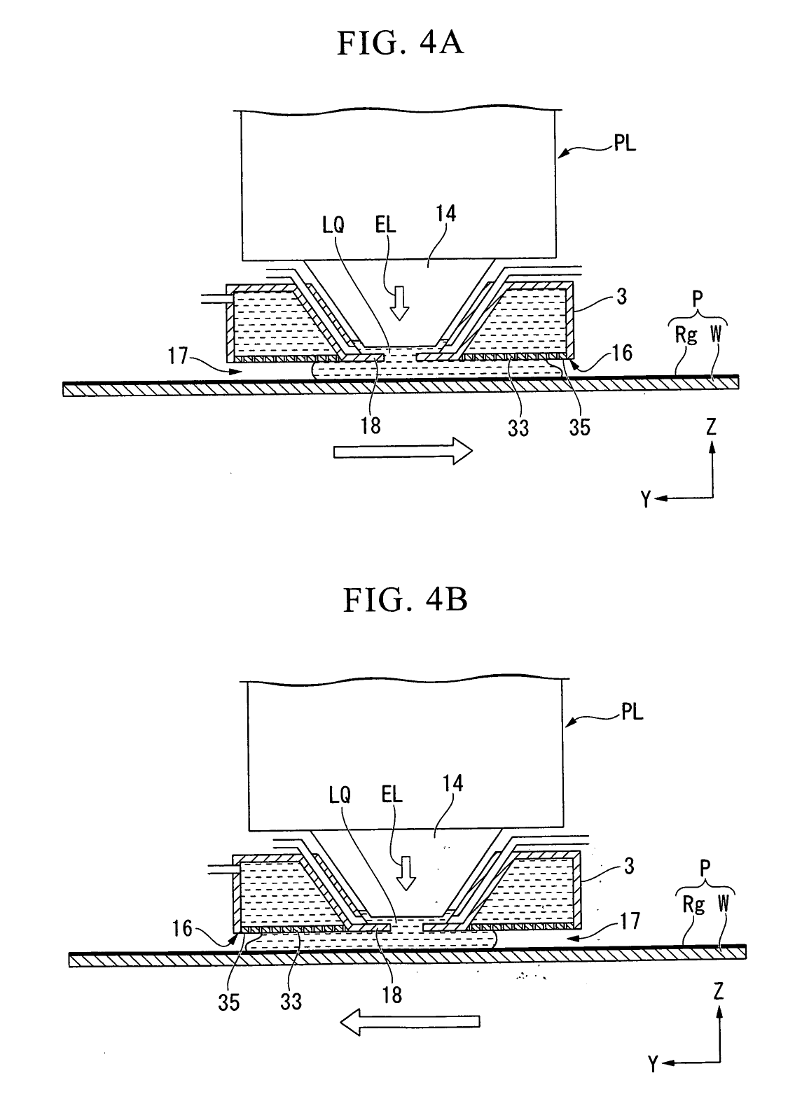

When the substrate P is exposed, the liquid LQ is supplied to the front surface of the substrate P via the supply ports 22 and is recovered from the front surface of the substrate P by the porous member 33 (i.e., via the recovery port 23). The control apparatus 5 supplies per unit of time a prescribed amount of the liquid LQ from the supply ports 22 and, by adjusting the negative pressure in the second space 31 so that per unit of time a prescribed amount of the liquid LQ is recovered via the porous member 33, adjusts the pressure differential between pressures at the lower surface 35 and at the upper surface 36 of the porous member 33. Thereby, the immersion space LS is formed with a prescribed size on the substrate P and the substrate P is exposed via the liquid LQ in the immersion space LS. In the present embodiment, when the exposure of the substrate P is started, the size of the immersion space LS is adjusted such that, in the state wherein the substrate P is substantially stationary as shown in, for example, FIG. 2, the interface LG of the liquid LQ in the immersion space LS is formed between the lower surface 35 of the porous member 33 and the front surface of the substrate P. Thereby, as shown in FIG. 4 and FIG. 4B, when the substrate P is exposed, the liquid LQ in the immersion space LS is held in the first space 17 between the lower surface 35 of the porous member 33 and the front surface of the substrate P even if the substrate P has moved in the scanning directions (i.e., the Y axial directions). Furthermore, FIG. 4A shows one example of the state of the immersion space LS when the substrate P is moving in the −Y direction, and FIG. 4B shows one example of the state of the immersion space LS when the substrate P is moving in the +Y direction.

During the exposure of the substrate P, it is possible that a substance (e.g., an organic substance like a photosensitive material) produced (i.e., peeled, eluted) from the substrate P will intermix with the liquid LQ of the immersion space LS as foreign matter (i.e., as a contaminant). In addition, along with the substance produced by the substrate P, foreign matter suspended in midair and the like might intermix with the liquid LQ of the immersion space LS. In the present embodiment, the liquid LQ of the immersion space LS (i.e., the first space 17) moves to the second space 31 via the holes 34 of the porous member 33. Accordingly, if foreign matter intermixes with the liquid LQ of the immersion space LS, then that foreign matter might adhere both to the holes 34 of the porous member 33 wherethrough the liquid LQ passes and to the upper surface 36 of the porous member 33, which faces the second space 31. Namely, if the foreign matter intermixes with the liquid LQ, that foreign matter might adhere to the liquid contact surface of the porous member 33, which contacts the liquid LQ. If the porous member 33 is left in a state wherein foreign matter is adhered to its liquid contact surface, then that foreign matter might likewise adhere to the substrate P during an exposure or contaminate the liquid LQ supplied via the supply ports 22. As a result, exposure failures such as, for example, the generation of defects in the pattern formed on the substrate P might occur.

Accordingly, in the present embodiment, the control apparatus 5 cleans the porous member 33 according to a prescribed timing.

Next, one example of a method of cleaning the porous member 33 will be explained.

In the present embodiment, when the cleaning process is performed, the substrate holding part 12 holds a dummy substrate DP. The dummy substrate DP is a member (i.e., a clean member) that is distinct from the substrate P used for exposure and has a high cleanliness level that tends not to release foreign matter. The external shape of the dummy substrate DP is substantially the same as that of the substrate P, and the substrate holding part 12 is capable of holding the dummy substrate DP. The dummy substrate DP comprises the base material W, such as a semiconductor wafer, and a film, which is formed on the base material W and is lyophilic with respect to the liquid LQ. The front surface of the dummy substrate DP includes the front surface of that lyophilic film. Were the base material W itself to be formed from a material that is lyophilic with respect to the liquid LQ, it alone could be used as the dummy substrate DP.

In the present embodiment, the transport apparatus 4 loads the dummy substrate DP onto the substrate holding part 12. The external shape of the dummy substrate DP is substantially the same as that of the substrate P, and the transport apparatus 4 is capable of transporting the dummy substrate DP. The control apparatus 5 uses the transport apparatus 4 to load the dummy substrate DP onto the substrate stage 2. The substrate stage 2 holds the loaded dummy substrate DP with the substrate holding part 12. Once the dummy substrate DP is held by the substrate holding part 12, the control apparatus 5, in order to clean the porous member 33, moves the substrate stage 2 such that the dummy substrate DP held thereon is disposed at a position at which it opposes the lower surface 35 of the porous member 33.

In the present embodiment, the control apparatus 5 cleans the porous member 33 by repetitively performing both the operation that supplies the liquid LQ from the supply ports 22 to the first space 17 and the operation that stops the supply of the liquid LQ to the first space 17 and negatively pressurizes (decreases the pressure in) the second space 31 such that the liquid LQ is substantially eliminated from the first space 17.

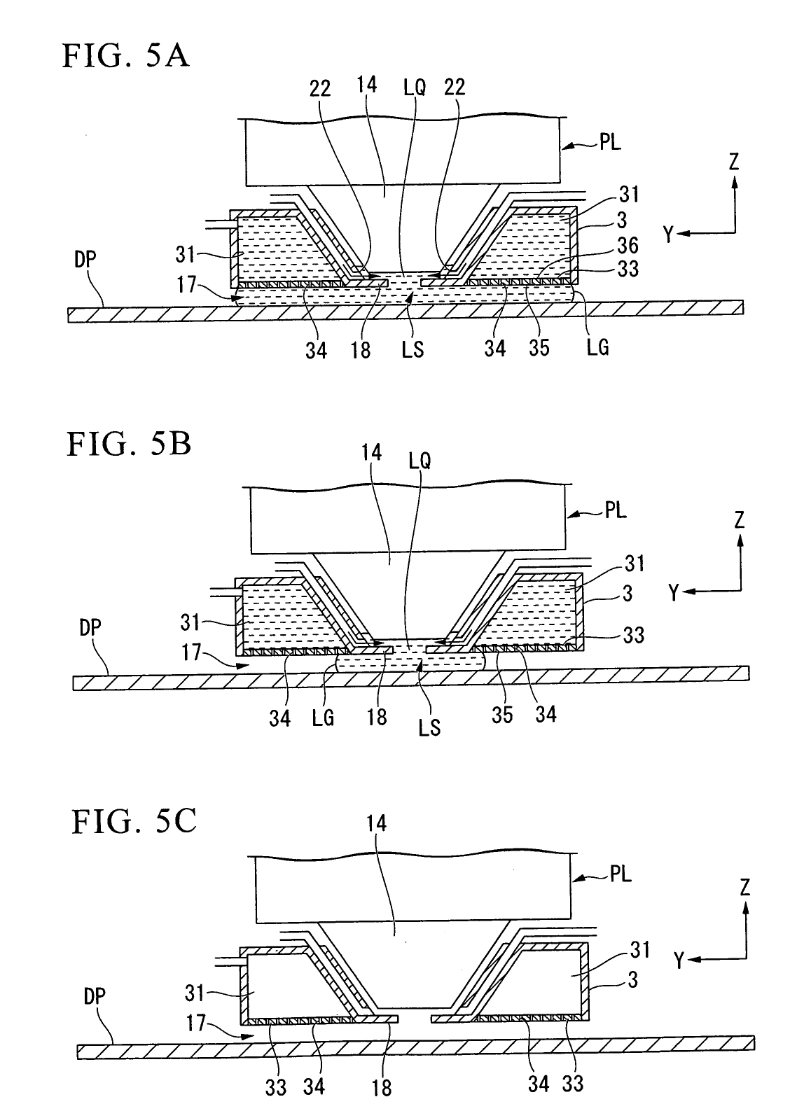

FIG. 5A, FIG. 5B and FIG. 5C are a schematic drawing that shows one example of the cleaning method of the present embodiment. As shown in FIGS. 5A-5C, when the porous member 33 is being cleaned, the front surface of the dummy substrate DP is disposed at a position at which it opposes the lower surface 35 of the porous member 33. Furthermore, the substrate stage 2 is omitted in FIGS. 5A-5C; however, as discussed above, the substrate stage 2 (i.e., the substrate holding part 12) holds the dummy substrate DP.

In the present embodiment, as shown in FIG. 5A, first, the size of the immersion space LS within the XY plane, in other words, the size of the immersion space LS on the dummy substrate DP is adjusted such that substantially the entire area of the lower surface 35 of the porous member 33 contacts the liquid LQ, in other words, such that substantially the entire first space 17 is filled with the liquid LQ. In the present embodiment, the control apparatus 5 sets a substantially constant amount of liquid for the supply ports 22 to supply per unit of time to the first space 17 and makes the pressure in the second space 31 higher than it is during the exposure of the substrate P. Namely, while supplying per unit of time a substantially constant quantity of the liquid LQ to the first space 17, the control apparatus 5 decreases the pressure differential between pressures at the lower surface 35 and at the upper surface 36 such that it is lower than it is during the exposure of the substrate P (i.e., the control apparatus 5 decreases the liquid recovery force of the porous member 33). Thereby, as shown in FIG. 5A, the immersion space LS within the XY plane is enlarged at least beyond the size it is during the exposure of the substrate P. In addition, in the state shown in FIG. 5A, the holes 34 of the porous member 33 as well as the second space 31 are filled with the liquid LQ. Furthermore, in the enlarged state of the liquid immersion space LS, a part of the lower surface 35 can make no contact with the liquid LQ.

Next, in the state wherein the operation of supplying the liquid LQ from the supply ports 22 to the first space 17 has been performed, the control apparatus 5 increases the pressure differential between pressures at the lower surface 35 and at the upper surface 36 (i.e., increases the force of the liquid recovery from the porous member 33) by adjusting the negative pressure in the second space 31. In the present embodiment, the pressure differential between pressures at the lower surface 35 and at the upper surface 36 is substantially the same as or greater than the pressure differential during the exposure of the substrate P. Thereby, the liquid LQ moves from the first space 17 to the second space 31 via the porous member 33; furthermore, in the first space 17 as shown in FIG. 5B, the interface LG of the liquid LQ in the immersion space LS on the dummy substrate DP moves such that the size of the immersion space LS decreases.

The control apparatus 5 stops the supply of the liquid LQ from the supply ports 22 to the first space 17 with a prescribed timing. In the state wherein the supply of the liquid LQ to the first space 17 is stopped, the negative pressure in the second space 31 is adjusted such that the liquid LQ moves from the first space 17 to the second space 31 via the porous member 33. Accordingly, in the state wherein the supply of the liquid LQ to the first space 17 is stopped, the liquid LQ in the first space 17 is recovered via the porous member 33. Furthermore, before increasing the pressure differential between pressures at the lower surface 35 and at the upper surface 36, or in the same time of the increasing the pressure differential, the supply of the liquid LQ via the supply ports 22 can be stopped.

In the present embodiment, the control apparatus 5 adjusts the negative pressure in the second space 31 such that the pressure differential between pressures at the lower surface 35 and at the upper surface 36 during the cleaning of the porous member 33 is greater than the pressure differential between pressures at the lower surface 35 and at the upper surface 36 during the exposure of the substrate P. In other words, in the state wherein the supply of the liquid LQ to the first space 17 is stopped, the control apparatus 5 increases the liquid recovery force during the cleaning of the porous member 33 such that it is greater than it is during an exposure.

By stopping the supply of the liquid LQ to the first space 17 and negatively pressurizing the second space 31, the liquid LQ in the first space 17 is substantially eliminated, as shown in FIG. 5C. In addition, in the present embodiment, the control apparatus 5 stops the supply of the liquid LQ to the first space 17 and negatively pressurizes the second space 31 such that at least part of the liquid LQ in the holes 34 of the porous member 33 is substantially eliminated. Furthermore, in the present embodiment, as shown in FIG. 5C, the supply of the liquid LQ to the first space 17 is stopped, and the second space 31 is negatively pressurized such that at least part of the liquid LQ in the second space 31 is substantially eliminated. In other words, the pressure in the second space 31 is adjusted (or decreased) such that the liquid LQ in the second space 31 is diminished. Furthermore, in the state shown in FIG. 5C, the liquid LQ may remain between the liquid immersion member 3 (i.e., the plate part 18) and the last optical element 14.

After the state shown in FIG. 5C, the control apparatus 5 starts (i.e., resumes) the operation of supplying the liquid LQ from the supply ports 22 to the first space 17. In the present embodiment, when the operation of supplying the liquid LQ from the supply ports 22 to the first space 17 is started (i.e., resumed), the control apparatus 5 stops the suction operation performed by the liquid recovery apparatus 30 (i.e., sets the liquid recovery force of the porous member 33 to substantially zero). Namely, the control apparatus 5 substantially zeroes the pressure differential between pressures at the lower surface 35 and at the upper surface 36. The control apparatus 5 sets a substantially constant amount of liquid for the supply ports 22 to supply per unit of time to the first space 17 and performs the operation of supplying the liquid LQ from the supply ports 22 to the first space 17. Thereby, the first space 17 is quickly filled with the liquid LQ from the supply ports 22. Furthermore, after the first space 17 has been filled with the liquid LQ such that substantially the entire area of the lower surface 35 of the porous member 33 contacts the liquid LQ, the control apparatus 5, in the state wherein the operation of supplying the liquid LQ to the first space 17 has continued, adjusts the negative pressure in the second space 31 such that the liquid LQ moves from the first space 17 to the second space 31 via the porous member 33. Thereby, the liquid LQ in the first space 17 moves to the second space 31 via the holes 34 of the porous member 33, and the holes 34 and the second space 31 are filled with the liquid LQ. In addition, in the present embodiment, the control apparatus 5 sets a substantially constant amount of liquid to be supplied per unit of time to the first space 17 and, when the liquid LQ is being supplied to the first space 17, the control apparatus 5 can cause the transition between, for example, the state shown in FIG. 5A and the state shown in FIG. 5B by changing the pressure in the second space 31. Alternatively, when the operation of supplying the liquid LQ from the supply port 22 is resumed, the suction operation performed by the liquid recovery apparatus 30 can be maintained without stop. For example, the supply of the liquid LQ can be resumed in a state where the pressure differential between the pressures at the lower surface 35 and at the upper surface 36 is set to be substantially same as or lower than that during exposing the substrate P.

In the present embodiment, repetitively performing the operation of supplying the liquid LQ to the first space 17 and the operation of stopping the supply of the liquid LQ to the first space 17 and negatively pressurizing the second space 31 causes the state to transition repetitively between the state wherein at least part of the first space 17 is filled with the liquid LQ and the state wherein the liquid LQ is substantially eliminated from the first space 17. In other words, the process of filling at least a part of the first space 17 with the liquid LQ by supplying the liquid LQ into the first space 17 and the process of substantially eliminating the liquid LQ from the first space 17 along the pressure gradient between the first space 17 and the second space 31 by halting the supply of the liquid LQ into the first space 17 are repetitively and alternately executed. Thereby, the porous member 33 is cleaned satisfactorily.

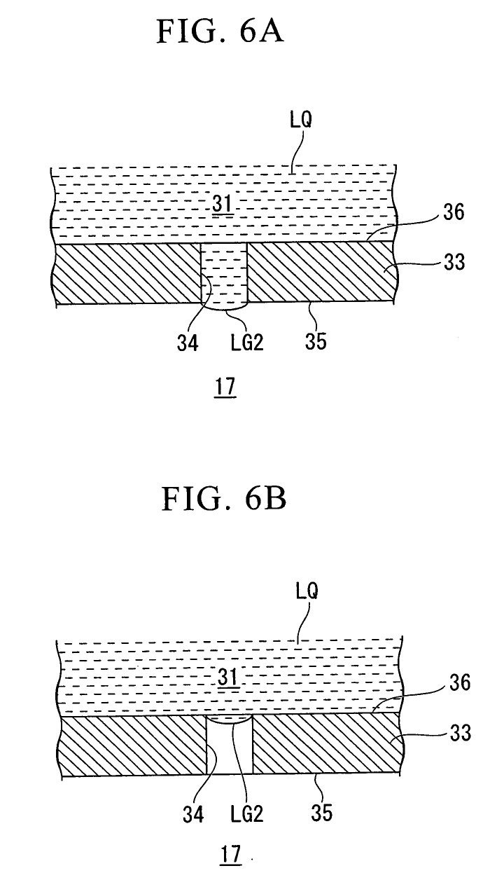

The repetition of the state wherein at least part of the first space 17 is filled with the liquid LQ and the state wherein the liquid LQ is substantially eliminated from the first space 17 causes the repetition of the state wherein the holes 34 are filled with the liquid LQ, as shown in FIG. 6A, and the state wherein the liquid LQ is substantially eliminated from the holes 34, as shown in FIG. 6B. Thereby, the inner surfaces of the holes 34 are cleaned. Because the repetition of the state wherein the holes 34 are filled with the liquid LQ and the state wherein the liquid LQ is substantially eliminated from the holes 34 moves the liquid LQ (i.e., an interface LG2 of the liquid LQ) with respect to the inner surfaces of the holes 34, the liquid LQ cleans the inner surfaces of the holes 34.

In addition, because the repetition of the state wherein at least part of the first space 17 is filled with the liquid LQ and the state wherein the liquid LQ is substantially eliminated from the first space 17 causes the repetition of the state wherein the second space 31 is filled with the liquid LQ and the state wherein the liquid LQ is substantially eliminated from the second space 31, the upper surface 36 of the porous member is cleaned. Because the repetition of the state wherein the second space 31 is filled with the liquid LQ and the state wherein the liquid LQ is substantially eliminated from the second space 31 moves the liquid LQ (i.e., the interface of the liquid LQ) with respect to the upper surface 36 of the porous member 33, the upper surface 36 is cleaned.

In addition, the repetition of the state wherein at least part of the first space 17 is filled with the liquid LQ and the state wherein the liquid LQ is substantially eliminated from the first space 17 cleans the lower surface 35 of the porous member 33. Because the repetition of the state wherein the first space 17 is filled with the liquid LQ and the state wherein the liquid LQ is substantially eliminated from the first space 17—such that the state transitions repetitively between, for example, the state shown in FIG. 5A and the state shown in FIG. 5C—moves the liquid LQ (i.e., the interface LG of the liquid LQ) with respect to the lower surface 35 of the porous member 33, the lower surface 35 is cleaned. In addition, the state may transition repetitively between, for example, the state shown in FIG. 5A and the state shown in FIG. 5B. For example, after the state passes through the state shown in FIG. 5C and the state shown in FIG. 5A and then transitions to the state shown in FIG. 5B, the state may transition repetitively between the state shown in FIG. 5A and the state shown in FIG. 5B. Because the liquid LQ (i.e., the interface LG of the liquid LQ) moves with respect to the lower surface 35 of the porous member 33, the lower surface 35 is cleaned. In particular, the enlargement of the immersion space LS such that substantially the entire area of the lower surface 35 of the porous member 33 contacts the liquid LQ as shown in FIG. 5A substantially cleans the entire area of the lower surface 35 satisfactorily. As shown in, for example, FIGS. 4A-4B, during the exposure of the substrate P, the lower surface 35 always includes a first area, which contacts the liquid LQ, and a second area, which repetitively transitions between the state wherein it contacts the liquid LQ and the state wherein it does not. The state of the adhered foreign matter (i.e., the contamination state) might differ from the first area to the second area. In the present embodiment, both the first area and the second area can be cleaned satisfactorily. In addition, the operation of repetitively transitioning between the state shown in FIG. 5A and the state shown in FIG. 5B may be omitted. Furthermore, in the state wherein the liquid LQ is substantially eliminated from the first space 17, at least a part of the second space 31 can be filled with the liquid LQ.

In the present embodiment as described above, the repetitive performance of a first operation, which supplies the liquid LQ to the first space 17, and a second operation, which stops the supply of the liquid LQ to the first space 17 and negatively pressurizes (decreases the pressure in) the second space 31 such that the liquid LQ is substantially eliminated from the first space 17, satisfactorily cleans the porous member 33. After the first operation and the second operation are performed repetitively a prescribed number of times, the cleaning process ends.

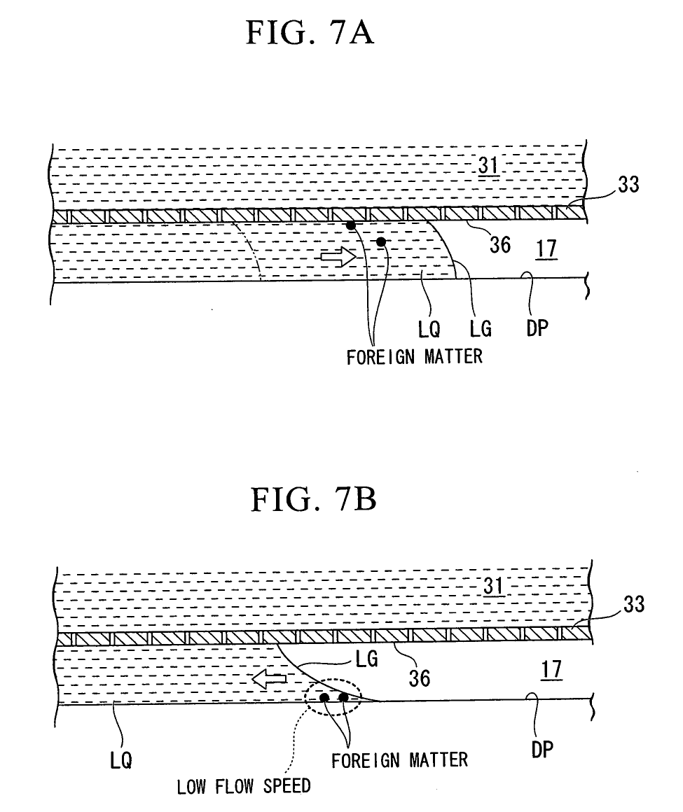

FIG. 7A and FIG. 7B schematically shows the state wherein the interface LG of the liquid LQ moves between the lower surface 35 of the porous member 33 and the dummy substrate DP. By repetitively transitioning between the state shown in FIG. 7A and the state shown in FIG. 7B, the foreign matter adhered to the porous member 33 is expelled from the porous member 33 by the force of the liquid LQ.

As discussed above, in the present embodiment, the front surface of the dummy substrate DP is lyophilic with respect to the liquid LQ. In the present embodiment, the contact angle of the liquid LQ with respect to the front surface of the dummy substrate DP is less than 90° and is preferably less than 50°. Thereby, when the state transitions, for example, from the state wherein the immersion space LS is large to the state wherein it is small, namely, from the state shown in FIG. 7A to the state shown in FIG. 7B, a portion wherein the flow speed of the liquid LQ is low arises in the vicinity of the front surface of the dummy substrate DP. As a result, there is a strong possibility that the foreign matter that was expelled from the porous member 33 into the liquid LQ will to adhere to the dummy substrate DP. Namely, in the state wherein the front surface of the dummy substrate DP, which is lyophilic with respect to the liquid LQ, is caused to oppose the porous member 33, the movement of the interface LG of the liquid LQ between the porous member 33 and dummy substrate DP makes it possible to capture the foreign matter expelled from the porous member 33 with the front surface of the dummy substrate DP.

In the present embodiment, after the process of cleaning the porous member 33 ends, the transport apparatus 4 unloads the dummy substrate DP from the substrate stage 2. Thereby, at least part of the foreign matter expelled from the porous member 33 is transported from the substrate stage 2 (i.e., the exposure apparatus EX) together with the dummy substrate DP.

After the process of cleaning the porous member 33 ends and the dummy substrate DP has been unloaded, the normal sequence, including the process of exposing the substrate P, is performed.

Furthermore, the present embodiment explained an exemplary case wherein if, for example, the size of the immersion space LS is changed or the state transitions between the state wherein at least part of the first space 17 is filled with the liquid LQ and the state wherein the liquid LQ is substantially eliminated from the first space 17, then a substantially constant amount of liquid supplied to the first space 17 per unit of time is set and, while performing the operation of supplying the liquid LQ to the first space 17, the pressure in the second space 31 is changed; however, of course, the amount of liquid supplied to the first space 17 per unit of time may be changed while keeping the pressure in the second space 31 constant, or both the amount of liquid supplied to the first space 17 per unit of time and the pressure in the second space 31 may be changed.

Furthermore, if the supply ports 22 are provided with a function that is capable of recovering the liquid LQ and if an operation that substantially eliminates the liquid LQ from the first space 17 is performed, then the operation of recovering the liquid from the supply ports 22 may be performed in parallel with the operation of recovering the liquid from the porous member 33. In addition, a recovery port separate from the porous member 33 (i.e., the recovery port 23) and the supply ports 22 may be provided, and an operation of recovering the liquid from that separate recovery port may be performed.

According to the present embodiment as explained above, the porous member 33 can be cleaned satisfactorily. Accordingly, it is possible to prevent exposure failures from occurring and defective devices from being produced.

### Second Embodiment

The following text explains a second embodiment. In the explanation below, constituent parts that are identical or equivalent to those in the embodiment discussed above are assigned identical symbols, and the explanations thereof are therefore abbreviated or omitted.

In the present embodiment, when the substrate P is not being exposed, the control apparatus 5 cleans the porous member 33 by supplying the liquid LQ from the supply ports 22 to the first space 17 and, while doing so, using the liquid recovery apparatus 30 to adjust the negative pressure in the second space 31 such that the pressure differential between pressures at the lower surface 35 and at the upper surface 36 is larger than it is during the exposure of the substrate P.

During the exposure of the substrate P, the control apparatus 5 controls the liquid recovery apparatus 30 so as to adjust the pressure differential between pressures at the lower surface 35 side and at the upper surface 36 side such that the liquid LQ alone moves from the lower surface 35 side (i.e., the first space 17 side) of the porous member 33 to the upper surface 36 side (i.e., the second space 31 side) via the holes 34 of the porous member 33, as disclosed in, for example, U.S. Pat. No. 7,292,313 and U.S. Patent Application Publication No. 2007/0139628. In the present embodiment, the pressure in the first space 17 is substantially atmospheric pressure. During an exposure of the substrate P, the control apparatus 5 adjusts the negative pressure in the second space 31 in accordance with the pressure in the first space 17 such that the liquid LQ alone moves from the first space 17 to the second space 31 via the holes 34 of the porous member 33.

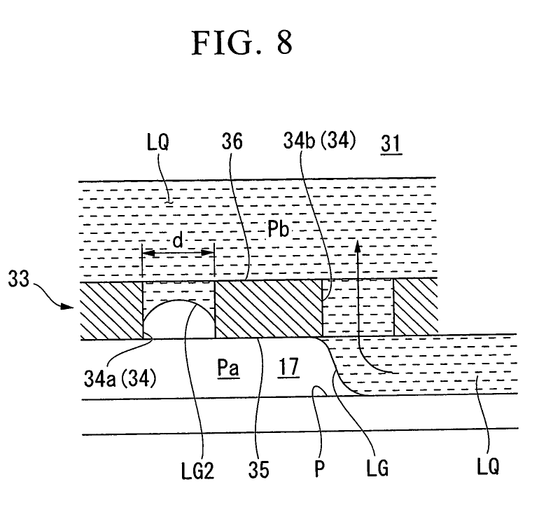

FIG. 8 is a schematic drawing that shows one example of the behavior of the liquid LQ during an exposure of the substrate P. As shown in FIG. 8, the interface LG is disposed between the lower surface 35 and the substrate P. The first space 17 between the porous member 33 and the substrate P includes a gas space and a liquid space. The gas space is formed between a first hole 34a of the porous member 33 and the substrate P, and the liquid space is formed between a second hole 34b and the substrate P. If we let Pa be the pressure in space between the first hole 34a and the substrate P (i.e., the pressure at the lower surface 35), Pb be the pressure in the second space 31 (i.e., the pressure at the upper surface 36), d be the hole diameter (i.e., the diameter) of holes 34a, 34b, θ be the contact angle of the liquid LQ with respect to the porous member 33 (i.e., the inner side of each of the holes 34), and γ be the surface tension of the liquid LQ, and if the condition below holds,

(4×γ×cos θ)/d≧(Pa−Pb) (1A)

then, as shown in FIG. 8, even if a gas space is formed on the lower side (i.e., the substrate P side) of the first hole 34a, it is possible to prevent the gas in the gas space on the lower side of the porous member 33 from moving to the second space 31 via the first hole 34a. Namely, by optimizing the contact angle θ, the hole diameter d, the surface tension γ of the liquid LQ, and the pressures Pa, Pb such that the condition in the abovementioned equation (1A) is satisfied, it is possible to maintain within the first hole 34a the interface LG2 between the gas and the liquid LQ in the first hole 34a and thereby to prevent the gas in the first hole 34a from penetrating the second space 31. Moreover, because the liquid space is formed on the lower side (i.e., the substrate P side) of the second hole 34b, it is possible to move the liquid LQ alone into the second space 31 via the second hole 34b. Furthermore, to simplify the explanation, the hydrostatic pressure of the liquid LQ above the porous member 33 is not taken into consideration in the condition expressed in the abovementioned equation (1A).

In the present embodiment, when the porous member 33 is being cleaned, the dummy substrate DP is disposed at a position at which it opposes the lower surface 35 of the porous member 33 and the first space 17, which is capable of holding liquid LQ, is formed between the lower surface 35 and the dummy substrate DP. While supplying the liquid LQ to the first space 17, the control apparatus 5 adjusts the negative pressure (i.e., a pressure Pb) in the second space 31 such that the pressure differential between pressures at the lower surface 35 and at the upper surface 36 (i.e., Pa−Pb) is greater than it is during the exposure of the substrate P. Namely, during cleaning, the control apparatus 5 increases the liquid recovery force of the porous member 33 to a level that is greater than the liquid recovery force of the porous member 33 during an exposure of the substrate P. The control apparatus 5 cleans the porous member 33 by performing the operation of recovering the liquid LQ using the porous member 33 in parallel with the operation of supplying the liquid LQ to the first space 17.

In the present embodiment, when the porous member 33 is being cleaned, the control apparatus 5 adjusts the negative pressure in the second space 31 by controlling the liquid recovery apparatus 30 such that the liquid LQ and the gas move to the second space 31 via the holes 34. In other words, the pressure in the second space 31 is decreased such that the condition of the above-described equation (1A) is not satisfied. For example, the control apparatus 5 adjusts the negative pressure in the second space 31 such that the state transitions repetitively between the state wherein the gas moves to the second space 31 via the holes 34 (i.e., the state where the gas is not drawn into the second space 31) and the state wherein the liquid LQ moves to the second space 31.

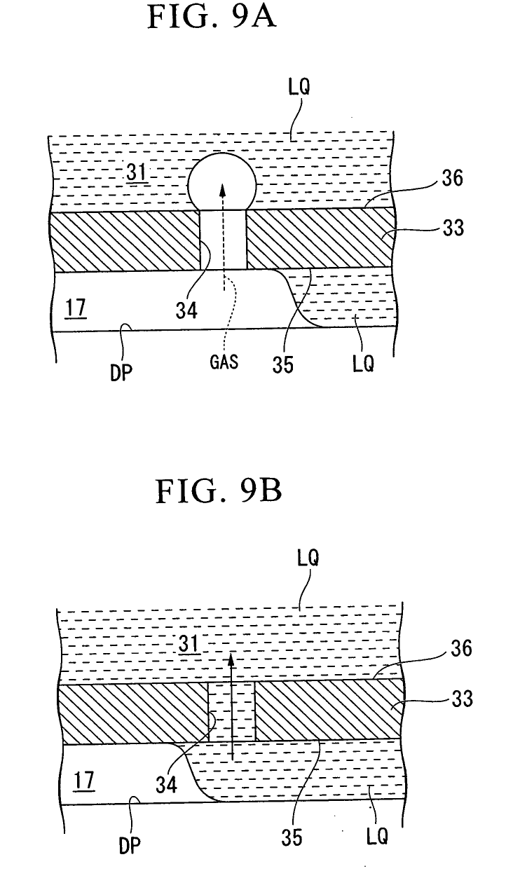

FIG. 9A and FIG. 9B is a schematic drawing that shows one example of the behavior of the liquid LQ when the porous member 33 is being cleaned. FIG. 9A shows the state wherein the gas moves to the second space 31 via the holes 34, and FIG. 9B shows the state wherein the liquid LQ moves to the second space 31 via the holes 34. If the negative pressure in the second space 31 is adjusted such that the condition in the abovementioned equation (1A) is not satisfied and the gas space is formed on the lower side (i.e., the dummy substrate DP side) of the holes 34 as shown in FIG. 9A, then the gas in that gas space moves to the second space 31 via the holes 34.

If the liquid LQ is supplied to the first space 17 and the liquid space is formed on the lower side (i.e., the dummy substrate DP side) of the holes 34, then the liquid LQ in the liquid space moves to the second space 31 via the holes 34.

While supplying the liquid LQ to the first space 17, the control apparatus 5 adjusts the negative pressure in the second space 31, which makes it possible to repetitively transition between the state wherein the gas moves to the second space 31 via the holes 34 as shown in FIG. 9A and the state wherein the liquid LQ moves to the second space 31. Thereby, the porous member 33 is cleaned. In the present embodiment, in a state where the liquid LQ exists in the first space 17, the state transitions repetitively between the state wherein the liquid LQ contacts the inner surfaces of the holes 34 and the state wherein it does not, which cleans the inner surfaces of the holes 34 satisfactorily.

Furthermore, in the second embodiment, the inner surfaces of the holes 34 and the lower surface 36 can be cleaned by alternately repeating the state where the pressure in the second space 31 is decreased and the state where the pressure in the second space is increased, in other words, by repeating the state where the liquid LQ is drawn into the second space 31 via the holes 34 and the state where the liquid LQ is extruded from the second space 31 via the holes 34.

Furthermore, in at least one of the statuses prior to and subsequent to the cleaning operation according to the above-discussed second embodiment, the other cleaning operation where the enlargement and the reduction of the liquid immersion space LS are repeated (i.e., where the state as shown in FIG. 5A and the state as shown in FIG. 5B are alternately repeated) can be executed.

Furthermore, the first and second embodiments discussed above explained exemplary cases wherein the porous member 33 is a mesh plate, but the porous member 33 does not have to be a plate; for example, a sintered member (e.g., sintered metal) or a foam member (e.g., metal foam), wherein numerous holes (i.e., pores) are formed, may be used as the porous member 33.

In addition, in each of the embodiments discussed above, the cleaning operation for the porous member 33 is explained, however, the liquid immersion member 3 can include no porous member 33. In this case, the lower surface of the liquid immersion member 3 and the inner surface of the recovery passageway can be cleaned by moving the interface LG of the liquid LQ on the lower surface of the liquid immersion member 3 or by moving the interface of the liquid LQ inside the recovery passageway of the liquid immersion member 3.

In addition, in each of the embodiments discussed above, cleaning was performed using the dummy substrate DP, whose front surface is lyophilic, but a dummy substrate may be used whose front surface is liquid repellent. Namely, when cleaning is performed, the immersion space LS may be formed on a liquid repellent front surface.

In addition, in each of the embodiments discussed above, when cleaning is performed, the immersion space LS is formed above the dummy substrate DP, but the immersion space LS may be formed above the upper surface 37 of the substrate stage 2 or an upper surface of a movable stage that is distinct from the substrate stage 2 and does not hold the substrate P.

In addition, in each of the embodiments discussed above, the liquid immersion member 3 may be provided such that it faces the −Z direction, similar to the recovery port 23.

In addition, the cleaning operation discussed above may be performed every time a prescribed time elapses or every time the substrate is processed a prescribed number of times, or both. In addition, the cleaning operation discussed above may be performed during idling time when the exposing process is not being performed. In addition, the cleaning operation discussed above may be performed when the number of defects produced in the substrate after an exposure exceeds a permissible range or when the contamination of the recovered liquid LQ (e.g., the number of particles in the liquid LQ) exceeds a permissible range. Or, the cleaning operation discussed above can be performed in at least one of statuses prior to and subsequent to the exposing process for a lot including a predetermined number of substrates P.

In addition, in each of the embodiments discussed above, the cleaning operation is performed by using liquid LQ; however, the cleaning operation discussed above can be performed by using a cleaning fluid other than the liquid LQ (e.g., alkaline cleaning fluid).

Furthermore, in the embodiments discussed above, the optical path on the emergent (i.e., image plane) side of the last optical element 14 of the projection optical system PL is filled with the liquid LQ; however, it is also possible to use a projection optical system wherein the optical path on the incident (i.e., object plane) side of the last optical element 14 is also filled with the liquid LQ as disclosed in, for example, PCT International Publication No. WO2004/019128.

Furthermore, although the liquid LQ in the embodiments discussed above is water, it may be a liquid other than water. For example, it is also possible to use hydro-fluoro-ether (HFE), perfluorinated polyether (PFPE), Fomblin® oil, or the like as the liquid LQ. In addition, it is also possible to use various fluids, for example, a supercritical fluid, as the liquid LQ.

Furthermore, the substrate P in the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (e.g., synthetic quartz or a silicon wafer) that is used by an exposure apparatus.

The exposure apparatus EX can also be adapted to a step-and-scan type scanning exposure apparatus (i.e., a scanning stepper) that scans and exposes the pattern of the mask M by synchronously moving the mask M and the substrate P, as well as to a step-and-repeat type projection exposure apparatus (i.e., a stepper) that successively steps the substrate P and performs a full field exposure of the pattern of the mask M with the mask M and the substrate P in a stationary state.

Furthermore, when performing an exposure with a step-and-repeat system, the projection optical system is used to transfer a reduced image of a first pattern onto the substrate P in a state wherein the first pattern and the substrate P are substantially stationary, after which the projection optical system may be used to perform a full-field exposure of the substrate P, wherein a reduced image of a second pattern partially superposes the transferred first pattern in a state wherein the second pattern and the substrate P are substantially stationary (i.e., as in a stitching type full-field exposure apparatus). In addition, the stitching type exposure apparatus can also be adapted to a step-and-stitch type exposure apparatus that successively steps the substrate P and transfers at least two patterns onto the substrate P such that they are partially superposed.

In addition, the exposure apparatus EX discussed above can also be, for example, an exposure apparatus that combines on a substrate the patterns of two masks through a projection optical system and double exposes, substantially simultaneously, a single shot region on the substrate P using a single scanning exposure, as disclosed in, for example, corresponding U.S. Pat. No. 6,611,316. In addition, the exposure apparatus EX discussed above can also be, for example, a proximity type exposure apparatus and a mirror projection aligner.

In addition, the exposure apparatus EX can also be a twin stage type exposure apparatus, which comprises a plurality of substrate stages, as disclosed in, for example, U.S. Pat. Nos. 6,341,007, 6,208,407, and 6,262,796.

Furthermore, as disclosed in, for example, U.S. Pat. No. 6,897,963 and European Patent Application Publication No. 1713113, the exposure apparatus EX discussed above can also be an exposure apparatus provided with a substrate stage that holds the substrate P and a measurement stage whereon either a fiducial member (wherein a fiducial mark is formed) or various photoelectric sensors, or both, are mounted. In addition, the exposure apparatus EX discussed above can be adapted to an exposure apparatus that comprises a plurality of substrate stages and measurement stages.

The type of exposure apparatus EX is not limited to a semiconductor device fabrication exposure apparatus that exposes the substrate P with the pattern of a semiconductor device, but can also be widely adapted to exposure apparatuses used to fabricate, for example, liquid crystal devices or displays and to exposure apparatuses used to fabricate thin film magnetic heads, image capturing devices (CCDs), micromachines, MEMS devices, DNA chips, or reticles and masks.

In addition, in the embodiments discussed above, an ArF excimer laser may be used as a light source apparatus that generates ArF excimer laser light, which serves as the exposure light EL; however, as disclosed in, for example, U.S. Pat. No. 7,023,610, a harmonic generation apparatus may be used that outputs pulsed light with a wavelength of 193 nm and that comprises: an optical amplifier part, which has a solid state laser light source (such as a DFB semiconductor laser or a fiber laser), a fiber amplifier, and the like; and a wavelength converting part. Moreover, in the abovementioned embodiments, both the illumination region and the projection region discussed above are rectangular, but they may be some other shape, for example, arcuate.

Furthermore, in the embodiments discussed above, an optically transmissive mask is used wherein a prescribed shielding pattern (or phase pattern or dimming pattern) is formed on an optically transmissive substrate; however, instead of such a mask, a variable pattern forming mask (also called an electronic mask, an active mask, or an image generator), wherein either a transmissive pattern and a reflective pattern or a light emitting pattern is formed based on electronic data of the pattern to be exposed, may be used as disclosed in, for example, U.S. Pat. No. 6,778,257. The variable pattern forming mask comprises a digital micromirror device (DMD), which is one kind of non-emissive type image display device (e.g., a spatial light modulator). In addition, instead of a variable pattern forming mask that comprises a non-emissive type image display device, a pattern forming apparatus that comprises a self luminous type image display device may be provided. Examples of a self luminous type image display device include a cathode ray tube (CRT), an inorganic electroluminescence display, an organic electroluminescence display (OLED: organic light emitting diode), an LED display, a laser diode (LD) display, a field emission display (FED), and a plasma display panel (PDP).

Each of the embodiments discussed above explained an exemplary case of an exposure apparatus that comprises the projection optical system PL, but an exposure apparatus and an exposing method that do not use the projection optical system PL can be used. Thus, even if the projection optical system PL is not used, the exposure light can be radiated to the substrate through optical members, such as lenses, and an immersion space can be formed in a prescribed space between the substrate and those optical members.

In addition, by forming interference fringes on the substrate P as disclosed in, for example, PCT International Publication No. WO2001/035168, the exposure apparatus EX can also be an exposure apparatus (i.e., a lithographic system) that exposes the substrate P with a line-and-space pattern.

As described above, the exposure apparatus EX of the present embodiment is manufactured by assembling various subsystems, as well as each constituent element, such that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes, for example, the mechanical interconnection of the various subsystems, the wiring and connection of electrical circuits, and the piping and connection of the atmospheric pressure circuit. Naturally, prior to performing the process of assembling the exposure apparatus from these various subsystems, there are also the processes of assembling each individual subsystem. When the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room wherein, for example, the temperature and the cleanliness level are controlled.

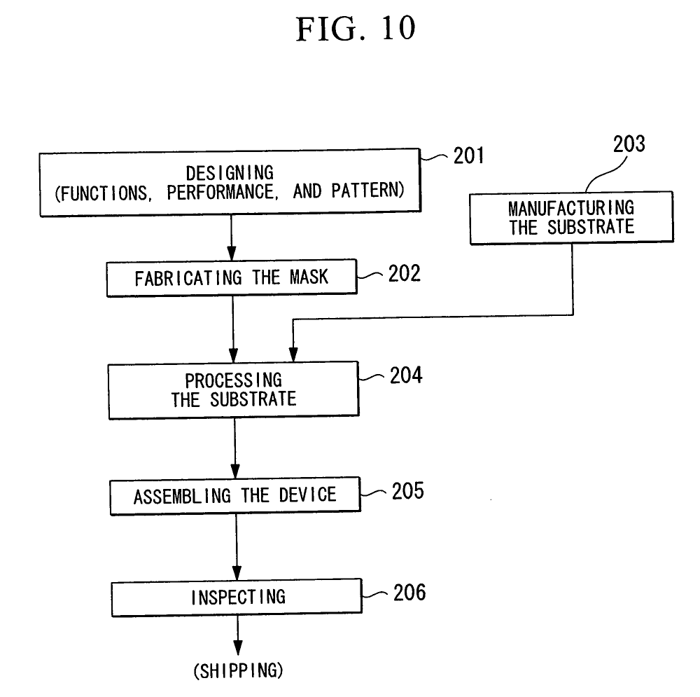

As shown in FIG. 10, a micro-device, such as a semiconductor device, is manufactured by: a step 201 that designs the functions and performance of the micro-device; a step 202 that fabricates the mask (i.e., a reticle) based on this designing step; a step 203 that manufactures the substrate, which is the base material of the device; a substrate processing step 204 that includes, in accordance with the embodiments discussed above, exposing the substrate with the exposure light that passes through the pattern of the mask and developing the exposed substrate; a device assembling step 205 (which includes fabrication processes such as dicing, bonding, and packaging processes); an inspecting step 206; and the like.

Furthermore, the features of each of the embodiments discussed above can be combined as appropriate. In addition, there may be cases wherein some of the constituent elements are not used. In addition, each disclosure of every published patent documents and U.S. patents related to the exposure apparatus recited in each of the embodiments, modified examples, and the like discussed above is hereby incorporated by reference in its entirety to the extent permitted by laws and regulations.

What is claimed is:

1. An exposure apparatus that exposes a substrate with exposure light that passes through a liquid, comprising:
a porous member that has a first surface, which is capable of opposing an object disposed at an irradiation position of the exposure light, and a second surface, which is on the opposite side of the first surface, and forms a first space that is capable of holding the liquid between the first surface and the object;
a supply port, which is capable of supplying the liquid to the first space;
a prescribed member, which forms a second space that faces the second surface;
an adjusting apparatus, which is capable of decreasing a pressure in the second space such that the liquid in the first space moves to the second space via holes in the porous member; and
a control apparatus, which controls an operation of supplying the liquid via the supply ports and a pressure adjustment operation performed by the adjusting apparatus;
wherein,
the control apparatus repetitively executes a first operation, which supplies the liquid to the first space, and a second operation, which stops the supply of the liquid to the first space and decreases a pressure in the second space such that the liquid is substantially eliminated from the first space, to clean the porous member.

2. An exposure apparatus according to claim 1, wherein
the adjusting apparatus decreases a pressure in the second space such that a pressure differential between pressures at the first surface and at the second surface during the cleaning is greater than a pressure differential between pressures at the first surface and at the second surface during an exposure of the substrate.

3. An exposure apparatus according to claim 1, wherein
the second operation substantially eliminates at least part of the liquid in the holes.

4. An exposure apparatus according to claim 1, wherein
the second operation substantially eliminates at least part of the liquid in the second space.

5. An exposure apparatus according to claim 1, wherein
the first operation fills at least some of the holes with the liquid.

6. An exposure apparatus according to claim 1, wherein
the first operation fills at least part of the first space with the liquid.

7. An exposure apparatus according to claim 1, wherein
the control apparatus changes the pressure in the second space during the first operation.

8. An exposure apparatus according to claim 7, wherein
the control apparatus sets a substantially constant amount of liquid to be supplied per unit of time to the first space and performs the first operation.

9. An exposure apparatus according to claim 1, wherein
the control apparatus changes the amount of liquid supplied per unit of time to the first space during the first operation.

10. An exposure apparatus according to claim 9, wherein
during the first operation, the control apparatus sets a substantially constant pressure in the second space or changes the pressure in the second space and thereby moves the liquid in the first space to the second space.

11. An exposure apparatus that exposes a substrate with exposure light that passes through a liquid, comprising:
a porous member that has a first surface, which is capable of opposing an object disposed at an irradiation position of the exposure light, and a second surface, which is on the opposite side of the first surface, and forms a first space that is capable of holding the liquid between the first surface and the object;
a supply port, which is capable of supplying the liquid to the first space;
a prescribed member, which forms a second space that faces the second surface;
an adjusting apparatus, which is capable of decreasing a pressure in the second space; and
a control apparatus, which controls an operation of supplying the liquid via the supply ports and a pressure adjustment operation performed by the adjusting apparatus;
wherein,
when the substrate is not being exposed, the control apparatus cleans the porous member by, while supplying the liquid to the first space, decreasing a pressure in the second space such that a pressure differential between pressures at the first surface and at the second surface is greater than a pressure differential between pressures at the first surface and at the second surface during an exposure of the substrate.

12. An exposure apparatus according to claim 11, wherein
during an exposure of the substrate, the adjusting apparatus decreases a pressure in the second space such that the liquid alone moves to the second space via the holes.

13. An exposure apparatus according to claim 11, wherein
during the cleaning of the porous member, the adjusting apparatus decreases a pressure in the second space such that the liquid and the gas move to the second space via the holes.

14. An exposure apparatus according to claim 11, wherein
the control apparatus cleans the inner surfaces of the holes.

15. An exposure apparatus according to claim 1, wherein
during the cleaning, the object that opposes the first surface is different from the substrate.

16. An exposure apparatus according to claim 15, wherein
a front surface of the object is hydrophilic with respect to the liquid.

17. An exposure apparatus according to claim 1, comprising:
a movable member, which releasably holds the substrate and is capable of holding the substrate at a position at which the movable member opposes the first surface,
wherein,
the movable member is capable of holding the object.

18. An exposure apparatus according to claim 17, comprising:
a transport apparatus, which transports the object from the movable member after the cleaning.

19. A device fabricating method, comprising:
exposing a substrate using an exposure apparatus according to claim 1; and
developing the exposed substrate.

20. A method of maintaining an exposure apparatus that exposes a substrate with exposure light that passes through a liquid, the method comprising:
causing an object and a porous member, which is capable of recovering the liquid from a front surface of the substrate during an exposure of the substrate, to oppose one another; and
cleaning the porous member by repetitively executing a first state, wherein the liquid is supplied to a first space between the porous member and the object and at least part of the first space is filled with the liquid, and a second state, wherein the supply of the liquid to the first space is stopped and the liquid is substantially eliminated from the first space.

21. A maintaining method according to claim 20, wherein
the porous member has a first surface, which faces the object, and a second surface, which faces a second space; and
in the first state and the second state, a pressure in the second space is decreased such that the liquid moves from the first space to the second space via the porous member.

22. A maintaining method according to claim 21, wherein
a pressure in the second space is decreased such that a pressure differential between pressures at the first surface and at the second surface during the cleaning is greater than a pressure differential between pressures at the first surface and at the second surface during the exposure of the substrate.

23. A maintaining method according to claim 20, wherein
in the second state, at least part of the liquid in the holes of the porous member is substantially eliminated.

24. A maintaining method according to claim 20, wherein
in the second state, at least part of the liquid in the second space is substantially eliminated.

25. A maintaining method according to claim 20, wherein
in the first state, at least some of the holes of the porous member are filled with the liquid.

26. A method of maintaining an exposure apparatus that exposes a substrate with exposure light that passes through a liquid, the method comprising:
causing an object and a porous member, which is capable of recovering the liquid from a front surface of the substrate during an exposure of the substrate, to oppose one another; and
cleaning the porous member by, while supplying the liquid to a first space between the porous member and the object, decreasing a pressure in the second space such that the liquid and a gas move to a second surface of the porous member, which is on the opposite side of a first surface thereof that faces the first space, via holes of the porous member.

27. A maintaining method according to claim 26, comprising:
cleaning the inner surfaces of the holes.

28. A maintaining method according to claim 20, wherein
the object is different from the substrate.

29. A maintaining method according to claim 28, wherein
the object's front surface is hydrophilic with respect to the liquid.

30. A maintaining method according to claim 20, wherein
the object is held by a movable member, which releasably holds the substrate and is capable of holding the substrate at a position at which it opposes the first surface.

31. A maintaining method according to claim 20, wherein
after the cleaning, at least some foreign matter expelled from the porous member is unloaded together with the object.

32. A method of maintaining an exposure apparatus that exposes a substrate with exposure light that passes through a liquid, comprising:
causing an object and a recovery port, which is capable of recovering the liquid from a front surface of the substrate during an exposure of the substrate, to oppose one another; and
while supplying a liquid onto the object, repetitively transitioning between a pressurization of a recovery passageway, which is connected with the recovery port, and a depressurization of the recovery passageway.

33. A device fabricating method, comprising:
exposing a substrate using an exposure apparatus that is maintained by the maintaining method according to claim 20; and
developing the exposed substrate.
